(19) United States
(12) Patent Application Publication
(10) Pub. No.: US 2025/0097681 A1
(43) Pub. Date: Mar. 20, 2025

(54) Method for a Network Component for Providing Bluetooth Control Data

(71) Applicant: Bayerische Motoren Werke Aktiengesellschaft, Muenchen (DE)

(72) Inventors: Sven Hofmann, Muenchen (DE); Stefan Diewald, Moosburg a. d. Isar (DE)

(21) Appl. No.: 18/729,766

(22) PCT Filed: Feb. 18, 2022
(86) PCT No.: PCT/EP2022/054144

§ 371 Date: Jul. 17, 2024

(30) Foreign Application Priority Data
Jan. 31, 2022 (DE) 10 2022 102 156.4

(51) Int. Cl. H04W 4/80; H04W 4/40; H04W 12/50

(52) U.S. Cl. CPC H04W 4/80; H04W 4/40; H04W 12/50

(57) ABSTRACT

A vehicle with a device for a network component for providing Bluetooth control data is disclosed herein. The device includes one or more interfaces for communication with a first user equipment and a second user equipment, and a controller in communication with the one or more interfaces. The controller is configured to obtain information for generating Bluetooth control data for establishing an encrypted Bluetooth connection between the first user equipment and the second user equipment on the basis of the information obtained. The controller is further configured to generate the Bluetooth control data and synchronize the Bluetooth control data between the first user equipment and the second user equipment.

### CROSS-REFERENCE TO RELATED APPLICATIONS

The present application is the U.S. national phase of PCT Application PCT/EP2022/054144 filed on Feb. 18, 2022, which claims priority of German patent application No. 10 2022 102 156.4 filed on Jan. 31, 2022, the entire contents of which are incorporated herein by reference.

### FIELD

The present disclosure relates to a method for a network component for providing Bluetooth control data, and more specifically to a concept for providing Bluetooth control data by synchronization of Bluetooth control data between a first user equipment and a second user equipment.

### BACKGROUND

The use of digital keys enables a user of a vehicle to open it particularly easily. In particular, by means of a smart access any user equipment can be configured to act as a digital key for a vehicle. For this purpose, for the configuration of a new user equipment a digital key—also called a data key—can be passed on to a user equipment, for instance from the vehicle. Hence the user equipment can be configured/authenticated in such a manner that access—for instance, opening, starting, etc. the vehicle—is made possible by radio, for instance with the aid of Bluetooth or ultra-wideband technology (UWB). However, for the purpose of opening/starting the vehicle the user equipment firstly has to establish a connection to the vehicle, for instance via Bluetooth, for which a first-time establishment of a Bluetooth connection, for instance via Bluetooth pairing, is required. The process of Bluetooth pairing can generate an undesirably high volume of data or an undesirable exchange of data. In addition, the process of Bluetooth pairing can take up an inconveniently long period of time for a user, as a result of which a user experience may be impaired. Furthermore, for each Bluetooth-enabled user equipment that would like to connect to the vehicle the vehicle firstly has to check whether an authorization for the respective user equipment exists. This may increase the energy consumption of the vehicle unnecessarily.

There is therefore a need to provide a generation of Bluetooth control data—for instance, Bluetooth encryption data and/or Bluetooth pairing data—and the synchronization thereof between a first user equipment and a second user equipment.

### SUMMARY

Embodiments are based on the central idea that an establishment of a Bluetooth connection can be improved, by Bluetooth control data—for instance, Bluetooth encryption data and/or Bluetooth pairing data—being generated and being synchronized between a first user equipment and a second user equipment. As a result, a first-time establishment of a Bluetooth connection, for instance, can be improved; for example, a Bluetooth pairing can be improved, for instance by using the Bluetooth encryption data and/or the Bluetooth pairing data. Furthermore, by virtue of the Bluetooth pairing data an initial pairing may become unnecessary, for instance because information needed for establishing a Bluetooth connection (for example, a long-term key, LTK) was sent to the first user equipment and to the second user equipment as a result of the synchronization.

Embodiments relate to a method for a network component, including obtaining information for generating Bluetooth control data for establishing an encrypted Bluetooth connection between a first user equipment and a second user equipment on the basis of the received information. The method further includes generating the Bluetooth control data and synchronizing the Bluetooth control data between the first user equipment and the second user equipment. As a result, a set-up of a Bluetooth connection can be improved.

In one embodiment, the Bluetooth control data may be Bluetooth encryption data. As a result, the first user equipment is able to set up a Bluetooth connection to the second user equipment in simplified form. In particular, the Bluetooth encryption data may include all the necessary parameters for establishing a Bluetooth connection, so no further exchange of information between the first user equipment and the second user equipment may be necessary for establishing a Bluetooth connection. In particular, a first-time establishment of a Bluetooth connection, which may happen at least partially in unencrypted manner, can be improved by a prior exchange of Bluetooth encryption data. In particular, a Bluetooth pairing can be carried out directly on the basis of the Bluetooth encryption data. As a result, in particular an exchange of information on the basis of out-of-band can be reduced and/or may take place at a different time. By this means, security can be enhanced, a Bluetooth connection set-up can be improved, and/or a data transfer can be reduced.

In one embodiment, the Bluetooth control data may be Bluetooth pairing data. Through use of the Bluetooth pairing data, in particular an initial Bluetooth pairing may become unnecessary. In particular, all the parameters needed for a Bluetooth pairing can already be communicated in advance to the first user equipment and to the second user equipment by virtue of the synchronization. For instance, the Bluetooth pairing data may include an LTK.

In one embodiment, the information obtained may include an identification for at least the first user equipment or the second user equipment. As a result, in particular an assignment/recognition of an authenticated user equipment, for instance a user equipment to be newly added which has obtained a data key, may take place.

In one embodiment, the network component may be an administrative platform or a further user equipment. For instance, an administrative platform can manage access to a vehicle and for this purpose can make Bluetooth control data available to at least one user equipment and to the vehicle. For example, a user equipment can manage data keys for opening the vehicle, which can be passed on to a further user equipment in order that the latter can gain access to the vehicle.

In one embodiment, the first user equipment may be a vehicle. As a result, in particular a Bluetooth connection between a vehicle and a user equipment, which in particular may take the form of a digital key, can be established in simplified manner.

In one embodiment, the Bluetooth control data can be generated in the vehicle. As a result, in particular the vehicle can improve an establishment of a Bluetooth connection between the vehicle and a user equipment without further infrastructure, such as an external administrative platform for example, being needed.

In one embodiment, the Bluetooth control data may include information about at least one parameter needed for a Bluetooth pairing. As a result, in particular a Bluetooth pairing between the first user equipment and the second user equipment can be improved.

In one embodiment, the method may further include encrypting the Bluetooth control data for the purpose of synchronization. As a result, it can be ensured that the Bluetooth control data cannot be read out by a third party.

Embodiments also provide a computer program for carrying out one of the methods described herein when the computer program is running on a computer, on a processor, or on a programmable hardware component.

A further embodiment is a device for a network component for providing Bluetooth control data. The device includes one or more interfaces, for communication with other communication appliances (for example, with the first user equipment and/or with the second user equipment), and a control module which has been designed to carry out at least one of the methods described herein. Embodiments provide, furthermore, a vehicle with a device as described herein.

### BRIEF DESCRIPTION OF THE DRAWINGS

Embodiments will be elucidated in more detail in the following paragraphs with reference to the accompanying figures:

FIG. 1 shows a schematic representation of an example of a method for providing Bluetooth control data;

FIG. 2 shows a schematic representation of an example of a method for providing encryption data;

FIG. 3 shows a block diagram of an embodiment of a device for a network component; and

FIG. 4a and FIG. 4b show two schematic representations for generating and for exchanging Bluetooth encryption data;

FIG. 5a and FIG. 5b show two schematic representations for generating and for exchanging Bluetooth pairing data.

Various embodiments will now be described in more detail with reference to the accompanying drawings in which some embodiments have been represented. In the figures, the thickness dimensions of lines, layers and/or regions may have been represented in exaggerated form for the sake of clarity.

### DESCRIPTION

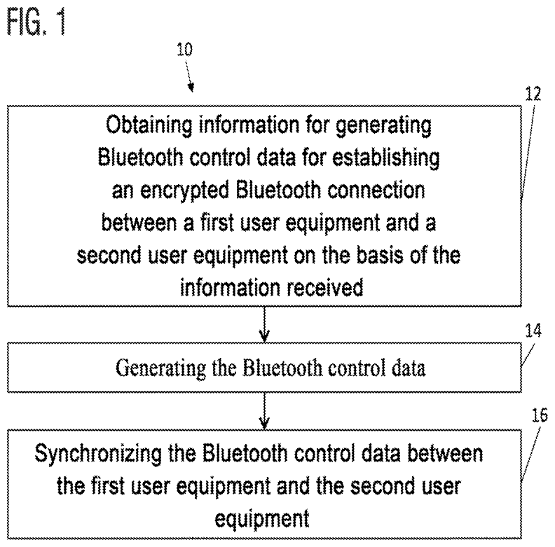

FIG. 1 shows a schematic representation of an example of a method 10 for providing Bluetooth control data. The method 10 includes obtaining 12 information for generating Bluetooth control data for establishing an encrypted Bluetooth connection between a first user equipment and a second user equipment on the basis of the information obtained. The method 10 further includes generating 14 the Bluetooth control data and synchronizing 16 the Bluetooth control data between the first user equipment and the second user equipment.

The first user equipment (UE) and/or the second user equipment may generally be an apparatus that is capable of communicating wirelessly. In particular, either the first UE or the second UE is a mobile UE, for example a UE that is suitable to be carried by a user. The first or second UE may be, for example, a user terminal (UT) or user equipment (UE) in the sense of the respective communication standards that are used for mobile communication. The first or second UE may be, for instance, a mobile phone, such as a smartphone, or another type of mobile communication apparatus, such as a smartwatch, a laptop, a tablet computer, autonomous augmented-reality glasses, etc. In particular, the first or second UE may be a digital key in the sense of the Car Connectivity Consortium (CCC) standard. For instance, standard CCC-TS-I01, Digital Key Technical Specification Release 3, Version 1.0.0, can be used for communication between UE and vehicle, for instance as described in “Bluetooth LE Pairing & Encryption Setup Procedure”, p. 347 ff. In particular, the generation of the Bluetooth control data—that is to say, the generating 14—can replace a known standard. For instance, the generation, described in chapter 18.4.9.: “Derivation of System Keys”, p. 290, of the Bluetooth control data can be replaced by the generating 14 of the network component. Furthermore, the exchange of information (data) between various user equipments can be expanded, for instance as described in Table 19-74: 7F49 Template, p. 346. The exchange can be expanded, in particular, by the synchronizing 16 of the network components. In addition, in the case where the network component is a back-end, for instance pertaining to a vehicle, an expansion, for instance in chapter 17.7.1.3 trackKeyResponse, p. 246, can be performed for the synchronizing 16.

In particular, the first UE can communicate with the second UE by means of a wireless personal area network (WPAN), for example Bluetooth, etc. In particular, the first UE can communicate with the second UE in the sense of IEEE 802.15.1-2005—IEEE standard for information technology. By virtue of the synchronizing 16, in particular a Bluetooth pairing and/or a password-authenticated key-agreement (PAKE) authentication can be simplified.

Obtaining 12 the information may include, in particular, determining or receiving. For instance, the information may be received from the first UE or from the second UE. Depending on the respective function of the network component, the information obtained may be diverse. For instance, the network component may be the first UE or the second UE. Alternatively, the network component may be a further UE. Alternatively, the network component may be an administrative platform. For instance, an administrative platform can determine the information for generating Bluetooth control data, for example on the basis of information about a rental of a vehicle, in particular by checking whether a payment for the rental has been made. For instance, the administrative platform can carry out a check before the information for generating is determined.

For instance, the network component may be a further UE, for example a master apparatus which manages data keys for access to a vehicle, for instance to the first UE. In particular, by means of a data key a second UE can be authenticated for the purpose of establishing a connection to the first UE. The further UE can send a data key to the second UE and, for instance, can obtain 12 reception information from the second UE. The further UE can furthermore generate 14 the Bluetooth control data and synchronize 16 said data between the first UE and the second UE. The synchronizing 16 may then include, or consist of, for instance, sending the Bluetooth control data to the first UE and to the second UE from the further UE. Alternatively, the further UE can be replaced by an administrative platform, in particular for the management of a plurality of vehicles.

For instance, the network component may be the first UE, which, for instance, is encompassed by a vehicle. The vehicle, or the first UE, can obtain 12 information from the second UE that includes a request to utilize the vehicle, for instance via an intermediate network component such as a server, for example. The vehicle, or the first UE, can then generate 14 Bluetooth control data and synchronize 16 said data. The synchronizing 16 may include, or consist of, sending the Bluetooth control data from the first UE to the second UE. Alternatively, the second UE, for instance a smartphone, can generate 14 and synchronize 16 the Bluetooth control data, in particular by sending said data to the vehicle, or to the first UE.

Generating 14 the Bluetooth control data may include, in particular, generating all the necessary parameters for establishing a Bluetooth connection, for instance parameters needed from the PAKE (specific to the owner pairing in the CCC standard) for establishing an encrypted connection, parameters from the Bluetooth pairing, etc. In particular, Bluetooth encryption data and/or Bluetooth pairing data may be encompassed by the Bluetooth encryption data. In particular, the Bluetooth encryption data may relate to an out-of-band communication. For instance, the use of the Bluetooth encryption data can simplify an out-of-band communication or even replace it by the synchronizing 16. In particular, the Bluetooth pairing data can simplify or replace an exchange of an LTK. As a result, an initial Bluetooth connection can be established in simplified manner, as a result of which, for instance, a waiting-time for a user for a set-up of a Bluetooth connection can be shortened.

By virtue of the generation 14 of the Bluetooth control data by means of the network component, these data can, in particular, be generated 14 on merely one electronic device, for instance on the network component. As a result, amongst other things, generation and transmission by the first UE or the second UE of information that on its own is not sufficient for the establishment of a Bluetooth connection may become unnecessary. Furthermore, a symmetrical generation of Bluetooth control data by means of the first UE and the second UE can also be dispensed with. By virtue of the obtaining 12 of the information and the generating 14 of the Bluetooth control data merely by means of the network component, an exchange of data between the first UE and the second UE can thereby be reduced. In addition, a Bluetooth connection can be established in simplified and/or improved manner.

Synchronizing 16 can enable a set-up of a Bluetooth connection between the first UE and the second UE, in particular without any necessity for an out-of-band communication, immediately prior to a first-time establishment of a Bluetooth connection. Furthermore, a first-time establishment of a Bluetooth connection can, for instance, be started without a prior exchange of information taking place by means of out-of-band between the first UE and the second UE. As a result, in particular a Bluetooth pairing can be improved, a data transfer can be reduced, and/or a user experience can be improved. For instance, an out-of-band communication can take place in advance, so a user no longer has to execute any further action in order that a first-time establishment of a Bluetooth connection can take place. For instance, the entering of a PIN for the Bluetooth connection to be established can be dispensed with. In addition, a Bluetooth connection between the first UE and the second UE can be set up without each UE generating its own parameters and exchanging them with the other UE. Furthermore, by virtue of a synchronizing 16 of Bluetooth pairing data, for instance of an LTK, a first initial Bluetooth connection can be improved or replaced.

By virtue of the synchronizing 16, in particular in the course of the first-time establishment of a Bluetooth connection between the first UE and the second UE, the determination of parameters necessary for this by the respective UE can accordingly be avoided. In particular, a generation of a subset of parameters for establishing a Bluetooth connection on both UEs, which requires an exchange of the subsets of parameters between the two UEs, can, as a result, be replaced by the synchronizing 16. In particular, a symmetrical derivation of necessary parameters by both UEs on the basis of the PAKE can be avoided. In particular, a determination of an LTK can be avoided.

In addition, through the use of the network component that generates 14 and synchronizes 16 the Bluetooth control data a detection of the second UE by the first UE can be improved. For instance, in an alternative system a further UE can make available, for instance to a second UE, a data key for the first UE but not all the necessary parameters for a key-exchange—that is to say, in order also to make access to the first UE possible for the second UE. Rather, for a first-time establishment of a Bluetooth connection to a second UE that has obtained a data key the first UE has to deactivate a security protocol in order that a connection can be established. By virtue of the generating 14 of the Bluetooth control data and the synchronizing 16, a deactivation of the security protocol can be avoided.

Furthermore, in an alternative system in which necessary parameters are generated during the first-time establishment of a Bluetooth connection the Bluetooth control data cannot be generated by an external entity, for instance an administrative platform, since the latter is not involved in the first-time establishment of the Bluetooth connection. By virtue of the generating 14 and the synchronizing 16, the Bluetooth control data can advantageously be generated 14 and shared, or synchronized 16, by an external entity, the network component, for instance an administrative platform.

For instance, a plurality of Bluetooth control data can be generated 14 for a plurality of user equipments, in particular by an intermediate network component such as a back-end, for example. The plurality of Bluetooth control data can then be synchronized 16 with the vehicle. As a result, the back-end can synchronize 16 Bluetooth control data to a plurality of user equipments without any necessity to carry out a synchronization with the vehicle each time. For instance, a plurality of Bluetooth control data can be generated 14, so for an addition of a new user equipment the back-end merely selects already generated Bluetooth control data that, in particular, have already been synchronized with the vehicle. For instance, the synchronization for the vehicle accordingly takes place prior to the synchronization for the user equipment.

In one embodiment, the Bluetooth control data may be Bluetooth encryption data. As a result, in particular an out-of-band communication, which can be used for a Bluetooth pairing, between the first UE and the second UE can be reduced or replaced.

In one embodiment, the Bluetooth control data may be Bluetooth pairing data. As a result, in particular the effort for establishing an initial Bluetooth connection can be reduced. In particular, by virtue of a synchronization 16 of LTKs an establishment of an initial Bluetooth connection can be avoided. As a result, a user experience can be improved, because, in particular, a waiting-time until a Bluetooth connection between the first UE and the second UE has been established can be reduced.

In one embodiment, the received information may include an identification for at least the first user equipment or the second user equipment. In particular, the information may include an identification for the first user equipment and/or the second user equipment. For instance, the network component may be the first UE, for instance encompassed by a vehicle, and may obtain information about an identification of the second UE. As a result, the vehicle can exit an energy-saving mode only after detection of a previously defined UE. In particular, an attempt to establish a Bluetooth connection by an alien UE that does not have an authentication for the vehicle cannot thereby have the result that the vehicle terminates the energy-saving mode. The vehicle—that is to say, the first UE—can accordingly, in particular, terminate the energy-saving mode only when a UE known to it, for example the second UE, is detected. As a result, the energy consumption of the first UE can be reduced.

In one embodiment, the network component may be an administrative platform or a further user equipment. The further UE may be, for instance, a master apparatus which has data keys for authenticating a UE, for instance the second UE. In particular, the master apparatus can thereby make available to the first UE and to the second UE all the information that is needed to simplify or to avoid a first establishment of a Bluetooth connection. For instance, the further UE can send the Bluetooth control data to the first UE and to the second UE. Optionally, the further UE can send information about an identification of the first UE, or second UE, to the second UE, or first UE, respectively. As a result, the first UE can detect the second UE, or the second UE can detect the first UE, in simplified manner.

An administrative platform may, in particular, be advantageous for management of a plurality of UEs, for instance a plurality of first UEs (for instance, several vehicles of a car-sharing fleet). The administrative platform can, for instance, generate Bluetooth control data for a first UE of a plurality of UEs for the second UE. As a result, access to the first UE of the plurality of UEs can be granted to the second UE.

In particular, in an application the Bluetooth control data may have been restricted, for instance to a period of time, to a location, to a usage behavior, etc. For instance, the Bluetooth control data may grant a user of the second UE access to a vehicle, for instance a vehicle from a car-sharing fleet, that includes the first UE. The Bluetooth control data may, for instance, have been linked to a rental period, to a rental location, to a number of possible utilizations, etc. As a result, an unwanted usage of the first UE by a user of the second UE can be prevented.

In one embodiment, the first user equipment may be a vehicle. For instance, an owner of the vehicle may possess a master apparatus, for instance a smartphone, which includes at least one data key. The owner can pass on this data key to a user of a second UE, in order that the second UE can gain access to the vehicle. By virtue of the generation 14 of the Bluetooth control data, the master apparatus can then make available to the second UE and to the first UE all the necessary parameters for establishing a Bluetooth connection.

In one embodiment, the Bluetooth control data can be generated in the vehicle. In particular, the Bluetooth control data can be generated on board. As a result, the vehicle may have been designed to simplify an establishment of Bluetooth a connection to a UE. Alternatively, the control Bluetooth data can be generated off board, for instance by an administrative platform or a UE. In particular, a transmission of the Bluetooth control data from the vehicle to the UE, for instance by means of near-field communication, Car2x messages, etc., can take place.

In one embodiment, the Bluetooth control data may include information about at least one parameter needed for a Bluetooth pairing. As a result, a Bluetooth pairing between the first UE and the second UE can be improved. For instance, the Bluetooth control data may be Bluetooth pairing data and may include an LTK. In particular, the first UE and/or the second UE can obtain all the parameters needed for an initial Bluetooth pairing from the network component, so this pairing can be omitted.

In one embodiment, the method 10 may further include encrypting the Bluetooth control data for the purpose of synchronization. As a result, it can be ensured that the Bluetooth control data cannot be read out by a third party.

The first UE and/or the second UE may generally be an apparatus that is capable of communicating wirelessly. In particular, the first UE and/or the second UE may be a mobile user equipment, for example a user equipment that is suitable to be carried by a user. The first UE and/or the second UE may be, for example, a user terminal (UT) or user equipment (UE) in the sense of the respective communication standards that are used for mobile communication. The first UE and/or the second UE may be, for instance, a mobile phone, such as a smartphone, or another type of mobile communication apparatus, such as a smartwatch, a laptop, a tablet computer, autonomous augmented-reality glasses, etc.

The network component may include, for instance, a computer, a processor, a control unit, a (field-)programmable logic array ((F)PLA), a (field-)programmable gate array ((F)PGA), a graphics-processing unit (GPU), an application-specific integrated circuit (ASIC), an integrated circuit (IC) or a system-on-a-chip (SoC). The network component may be, for instance, a user equipment.

The network component may generally be an apparatus that is capable of communicating wirelessly. The network component may be an apparatus in the sense of the respective communication standards that can be used for mobile communication.

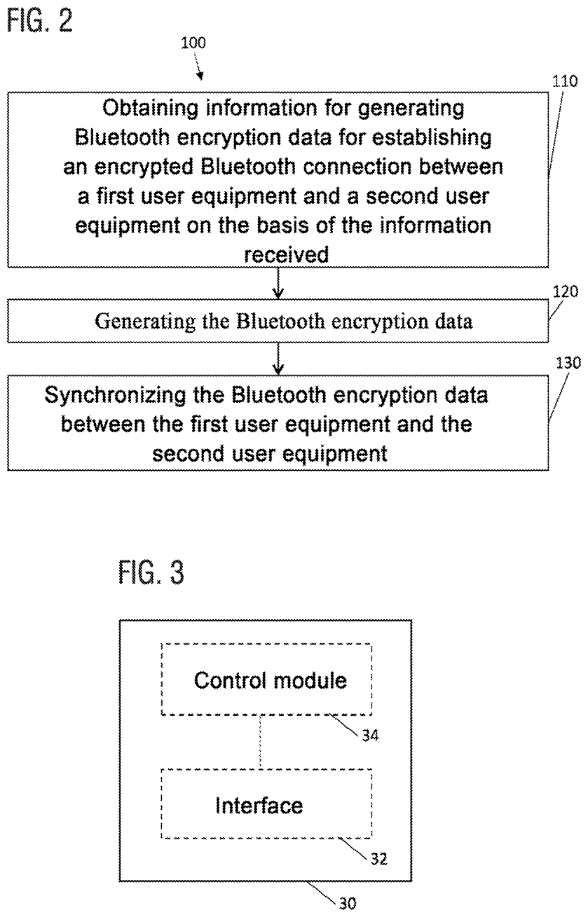

Further particulars and aspects will be mentioned in connection with the embodiments described below. The embodiment shown in FIG. 1 may include one or more optional additional features that correspond to one or more aspects that were mentioned in connection with the proposed concept or in connection with one or more embodiments described below (for example, FIGS. 2-5).

FIG. 2 shows a schematic representation of an example of a method 100 for providing Bluetooth encryption data. The method includes obtaining 110 information for generating Bluetooth encryption data for establishing an encrypted Bluetooth connection between a first user equipment and a second user equipment on the basis of the information received. The method 100 further includes generating 120 the Bluetooth encryption data and synchronizing 130 the Bluetooth encryption data between the first user equipment and the second user equipment. All types of Bluetooth protocols, for instance Bluetooth Low Energy, may be encompassed by the term “Bluetooth”.

The first user equipment (UE) and/or the second user equipment may generally be an apparatus that is capable of communicating wirelessly. In particular, either the first UE or the second UE is a mobile UE, for example a UE that is suitable to be carried by a user. The first or second UE may be, for example, a user terminal (UT) or user equipment (UE) in the sense of the respective communication standards that are used for mobile communication. The first second UE may be, for instance, a mobile phone, such as a smartphone, or another type of mobile communication apparatus, such as a smartwatch, a laptop, a tablet computer, autonomous augmented-reality glasses, etc. In particular, the first or second UE may be a digital key in the sense of the Car Connectivity Consortium (CCC) standard. For instance, standard CCC-TS-101, Digital Key Technical Specification Release 3, Version 1.0.0, can be used for communication between UE and vehicle, for instance as described in “Bluetooth LE Pairing & Encryption Setup Procedure”, p. 347 ff. In particular, the generation of the Bluetooth encryption data—that is to say, the generating 120—can replace a known standard. For instance, the generation of the Bluetooth encryption data that is described in chapter 18.4.9. “Derivation of System Keys”, p. 290, can be replaced by the generating 120 of the network component. Furthermore, the exchange of information (data) between various user equipments can be expanded, for instance as described in Table 19-74: 7F49 Template, p. 346. The exchange can be expanded, in particular, by the synchronizing 130 of the network components. In addition, in the case where the network component is a back-end, for instance pertaining to a vehicle, an expansion for the synchronizing 130 can be performed, for instance in chapter 17.7.1.3 trackKeyResponse, p. 246.

In particular, the first UE can communicate with the second UE by means of a wireless personal area network (WPAN), for example Bluetooth, etc. In particular, the first UE can communicate with the second UE in the sense of IEEE 802.15.1-2005—IEEE standard for information technology. By virtue of the synchronizing 130, in particular a Bluetooth pairing and/or password-authenticated key-agreement (PAKE) authentication can be simplified.

Obtaining 110 the information may include, in particular, determining or receiving. Depending on the respective function of the network component, the information obtained may be diverse. For instance, the network component may be the first UE or the second UE. Alternatively, the network component may be a further UE. Alternatively, the network component may be an administrative platform.

For instance, the network component may be a further UE, for example a master apparatus which manages data keys for access to a vehicle, for instance to the first UE.

In particular, by means of a data key a second UE can be authenticated for the purpose of establishing a connection to the first UE. The further UE can send a data key to the second UE and, for instance, obtain 110 reception information from the second UE. The further UE can furthermore generate 120 the Bluetooth encryption data and synchronize 130 said data between the first UE and the second UE. The synchronizing 130 may then include, or consist for of, instance, sending the Bluetooth encryption data to the first UE and to the second UE from the further UE. Alternatively, the further UE can be replaced by an administrative platform, in particular for the management of a plurality of vehicles.

For instance, the network component may be the first UE, which, for instance, is encompassed by a vehicle. The vehicle, or the first UE, can obtain 110 information from the second UE that includes a request to utilize the vehicle, for instance via an intermediate network component such as a server, for example. The vehicle, or the first UE, can then generate 120 Bluetooth encryption data and synchronize 130 said data. The synchronizing 130 may include, or consist of, sending the Bluetooth encryption data from the first UE to the second UE. Alternatively, the second UE, for instance a smartphone, can generate 120 and synchronize 130 the Bluetooth encryption data, in particular by sending said data to the vehicle, or to the first UE.

Generating 120 the Bluetooth encryption data may include, in particular, generating all the necessary parameters for establishing a Bluetooth connection, for instance parameters needed from the PAKE for establishing an encrypted connection, parameters from the Bluetooth pairing, etc. By virtue of the generation 120 of the Bluetooth encryption data by means of the network component, these data can, in particular, be generated on merely one electronic device. As a result, amongst other things, generation and transmission by the first UE or the second UE of some parameters that on their own are not sufficient for the establishment of a Bluetooth connection become unnecessary. Furthermore, a symmetrical generation of Bluetooth encryption data by means of the first UE and the second UE can also be dispensed with. By obtaining 110 the information and generating 120 the Bluetooth encryption data merely by means of the network component, an exchange of data between the first UE and the second UE can thereby be reduced. In addition, a Bluetooth connection can be established in simplified and/or improved manner.

Synchronizing 130 can make a set-up of a Bluetooth connection possible between the first UE and the second UE, in particular without any necessity for an out-of-band communication, immediately prior to a first-time establishment of a Bluetooth connection. For instance, a first-time establishment of a Bluetooth connection can be started without a prior exchange of information by means of out-of-band between the first UE and the second UE taking place. As a result, in particular a Bluetooth pairing can be improved, a data transfer can be reduced, and/or a user experience can be improved. For instance, an out-of-band communication can take place in advance, so a user no longer has to execute any further action in order that a first-time establishment of a Bluetooth connection can take place. For instance, the entering of a PIN for the Bluetooth connection to be established can be dispensed with. In addition, a Bluetooth connection between the first UE and the second UE can be set up, without each UE generating its own parameters and exchanging them with the other UE.

By virtue of the synchronizing 130, in particular in the course of the first-time establishment of a Bluetooth connection between the first UE and the second UE, the determination of parameters necessary for this by the respective UE can accordingly be avoided. In particular, a generation of a subset of parameters for establishing a Bluetooth connection on both UEs, which requires an exchange of the subsets of parameters between the two UEs, can as a result be replaced by the synchronizing 130. In particular, a symmetrical derivation of necessary parameters by both UEs on the basis of the PAKE can be avoided.

In addition, through the use of the network component that generates 120 and synchronizes 130 the Bluetooth encryption data a detection of the second UE by the first UE can be improved. For instance, in an alternative system a further UE can make available, for instance to a second UE, a data key for the first UE but not all the necessary parameters for a key-exchange—that is to say, in order also to make access to the first UE possible for the second UE. Rather, for a first-time establishment of a Bluetooth connection to a second UE that has obtained a data key the first UE has to deactivate a security protocol, in order that a connection can be established. By virtue of the generating 120 of the Bluetooth encryption data and the synchronizing 130, a deactivation of the security protocol can be avoided.

Furthermore, in an alternative system in which necessary parameters are during generated the first-time establishment of a Bluetooth connection the Bluetooth encryption data cannot be generated by an external entity, for instance an administrative platform, since the latter is not involved in the first-time establishment of the Bluetooth connection. By virtue of the generating 120 and the synchronizing 130, the Bluetooth encryption data can advantageously be generated and shared by an external entity, the network component, for instance an administrative platform.

In one embodiment, the received information may include an identification for at least the first user equipment or the second user equipment. In particular, the information may include an identification for the first user equipment and/or the second user equipment. For instance, the network component may be the first UE, for instance encompassed by a vehicle, and may obtain information about an identification of the second UE. As a result, the vehicle can exit an energy-saving mode only after detection of a previously defined UE. In particular, an attempt by an alien UE that does not have an authentication for the vehicle to establish a Bluetooth connection cannot thereby have the result that the vehicle terminates the energy-saving mode. The vehicle—that is to say, the first UE—can accordingly terminate the energy-saving mode only when a UE known to it, for example the second UE, is detected. As a result, the energy consumption of the first UE can be reduced.

In one embodiment, the network component may be an administrative platform or a further user equipment. The further UE may be, for instance, a master apparatus which has data keys for authenticating a UE, for instance the second UE. In particular, the master apparatus can thereby make available to the first UE and to the second UE all the information that is needed in order to simplify or to avoid a first establishment of a Bluetooth connection. For instance, the further UE can send the Bluetooth encryption data to the first UE and to the second UE. Optionally, the further UE can send information about an identification of the first UE, or second UE, to the second UE, or first UE, respectively. As a result, the first UE can detect the second UE, or the second UE can detect the first UE, in simplified manner.

An administrative platform may be advantageous, in particular, for management of a plurality of UEs, for instance a plurality of first UEs (for instance, several vehicles of a car-sharing fleet). The administrative platform can, for instance, generate Bluetooth encryption data for a first UE of a plurality of UEs for the second UE. As a result, access to the first UE of the plurality of UEs can be granted to the second UE.

In particular, in an application the Bluetooth encryption data may have been restricted, for instance to a period of time, to a location, to a usage behavior, etc. For instance, the Bluetooth encryption data may grant a user of the second UE access to a vehicle, for instance a vehicle from a car-sharing fleet, that includes the first UE. The Bluetooth encryption data may, for instance, have been linked to a rental period, to a rental location, to a number of possible utilizations, etc. As a result, an unwanted usage of the first UE by a user of the second UE can be prevented.

In one embodiment, the first user equipment may be a vehicle. For instance, an owner of the vehicle may possess a master apparatus, for instance a smartphone, which includes at least one data key. The owner can pass on this data key to a user of a second UE, in order that the second UE can gain access to the vehicle. By virtue of the generation 120 of the Bluetooth encryption data, the master apparatus can then make available to the second UE and to the first UE all the necessary parameters for establishing a Bluetooth connection.

In one embodiment, the Bluetooth encryption data can be generated in the vehicle. In particular, the Bluetooth encryption data can be generated on board. As a result, the vehicle may have been designed to simplify an establishment of a Bluetooth connection to a UE. Alternatively, the Bluetooth encryption data can be generated off board, for instance by an administrative platform or a UE.

In one embodiment, the Bluetooth encryption data may include information about at least one parameter needed for a Bluetooth pairing. As a result, a Bluetooth pairing between the first UE and the second UE can be improved. In particular, the first UE and/or the second UE can obtain all the parameters needed for a Bluetooth pairing from the network component.

In one embodiment, the method 100 may further include encrypting the Bluetooth encryption data for the purpose of synchronization. As a result, it can be ensured that the Bluetooth encryption data cannot be read out by a third party.

Further particulars and aspects are mentioned in connection with the embodiments described below and/or above. The embodiment shown in FIG. 2 may include one or more optional additional features that correspond to one or more aspects that were mentioned in connection with the proposed concept or in connection with one or more embodiments described above (for example, FIG. 1) and/or below (for example, FIGS. 3-5).

FIG. 3 shows a block diagram of an embodiment of a device 30 for a network component. The device 30 for providing Bluetooth control data (in particular, Bluetooth encryption data and/or Bluetooth control data) includes one or more interfaces 32 for communication with a user equipment (for instance, the first UE and/or the second UE). The device 30 further includes a control module 34 which has been designed to carry out at least one of the methods described herein, for instance the method that has been described with reference to FIG. 1 or FIG. 2. Further embodiments are a vehicle with a device 30.

The one or more interfaces 32 may, for instance, correspond to one or more inputs and/or one or more outputs for receiving and/or transmitting information, for instance in digital bit values, on the basis of a code, within a module, between modules, or between modules of various entities. The at least one or more interfaces 32 may, for instance, have been designed to communicate with other network components via a (radio) network or a local connection network.

As represented in FIG. 3, the one or more interfaces 32 have been coupled to the respective control module 34 of the device 30. In examples, the device 30 can be implemented by means of one or more processing units, one or more processing apparatuses, an arbitrary processing means such as, for example, a processor, a computer or a programmable hardware component that can be operated with appropriately adapted software (it will be recognized that any of the foregoing may be referred to herein as simply a “processor”). Similarly, the described functions of the control module 34 can also be implemented in software which is then executed on one or more programmable hardware components. Such hardware components may be a multi-purpose processor, a digital signal processor (DSP), a microcontroller, etc. The control module 34 may be capable of controlling the one or more interfaces 32 in such a way that each data transmission that takes place via the one or more interfaces 32, and/or each interaction in which the one or more interfaces 32 may be involved, can be controlled by the control module 34.

In embodiments, the control module 34 may correspond to an arbitrary controller or processor or to a programmable hardware component. For instance, the control module 34 may also have been realized as software that has been programmed for an appropriate hardware component. In this respect, the control module 34 may have been implemented as programmable hardware with appropriately adapted software. Arbitrary processors, such as digital signal processors (DSPs), may come into operation. Embodiments are not restricted to a specific type of processor. Arbitrary processors, or even several processors, are conceivable for implementing the control module 34.

In one embodiment, the device 30 may include a memory and at least one control module 34 which has been operably coupled with the memory and configured in such a way that it carries out the method described below.

In examples, the one or more interfaces 32 may correspond to any means for obtaining, receiving, transmitting or providing analog or digital signals or information, for example any coupling, contact, pin, register, input terminal, output terminal, conductor, track, etc. that enables a signal or information to be provided or obtained. The one or more interfaces 32 may be wireless or hard-wired and may have been configured in such a way that they can communicate with further internal or external components, for example can send or receive signals or information.

In at least some embodiments, the vehicle may correspond to, for instance, a land vehicle, a watercraft, an aircraft, a rail vehicle, a road vehicle, a car, a bus, a motorcycle, an off-road vehicle, a motor vehicle or a truck. The control module may be, for instance, a part of a control unit of the vehicle. The device 30 can also be employed in other Bluetooth-enabled electronic devices, such as, for example, a Bluetooth speaker, a Bluetooth headset, a smartphone, etc.

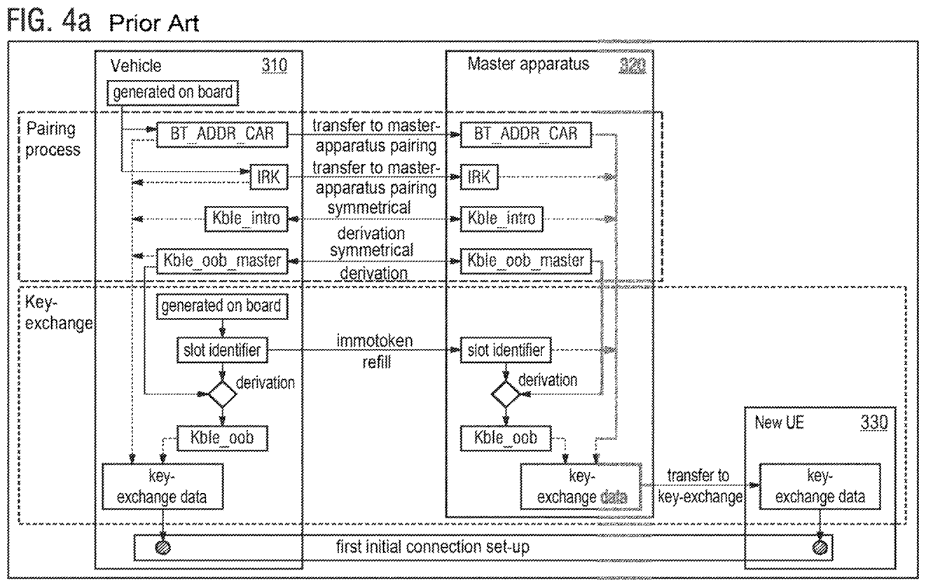

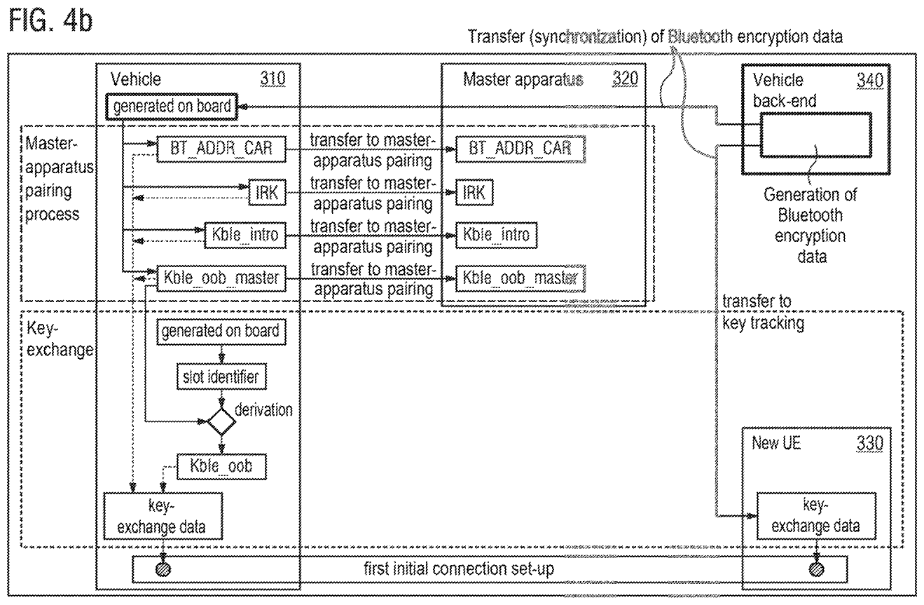

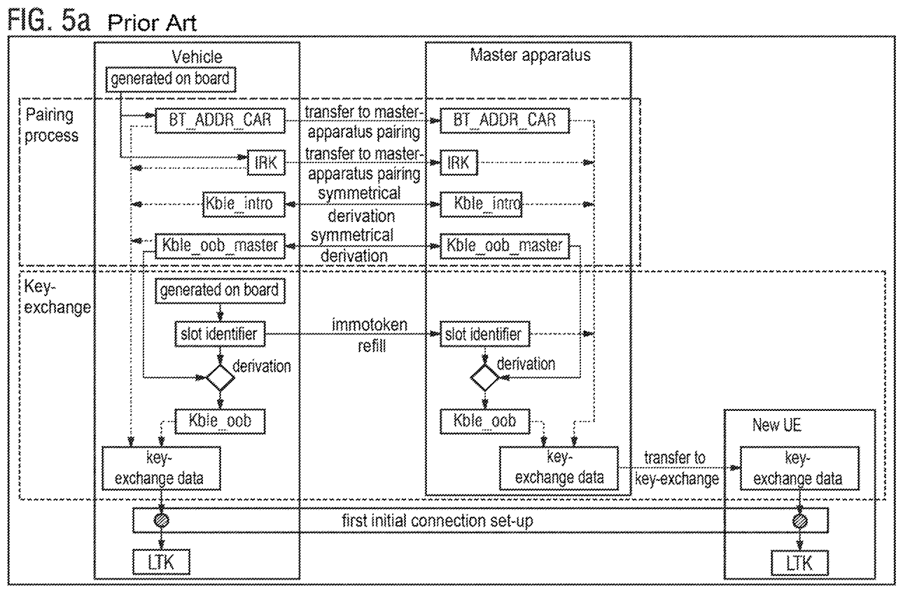

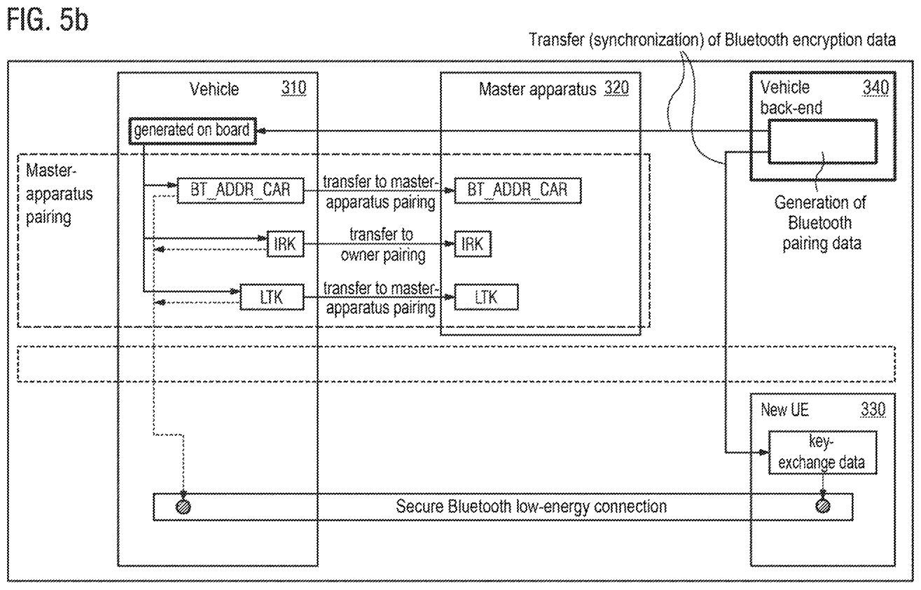

Further particulars and aspects are mentioned in connection with the embodiments described below and/or above. The embodiment shown in FIG. 3 may include one or more optional additional features that correspond to one or more aspects that were mentioned in connection with the proposed concept or in connection with one or more embodiments described above (for example, FIGS. 1-2) and/or below (for example, FIGS. 4-5).

FIG. 4 shows two schematic representations for generating and exchanging Bluetooth encryption data. FIG. 4a shows the prior art. In particular in FIG. 4a, a symmetrical generation of parameters needed—for instance, kble_info and kble_oob_master—takes place in the course of the pairing process between a master apparatus and a vehicle. These parameters then have to be exchanged between the two UEs 310, 320—that is to say, the vehicle 310 and the master apparatus 320. Furthermore, also in the course of the key-exchange the master apparatus 320 needs yet further information from the vehicle 310 so that the master apparatus 320 can make all the necessary parameters available to the user equipment 330 to be newly added only after a key-exchange between the vehicle 310 and the master apparatus 320 has taken place.

FIG. 4b shows a schematic representation of an example of a method according to the disclosure, for instance an embodiment of a method that was described with reference to FIG. 1.

In FIG. 4b, the network component 340 which generates and synchronizes the Bluetooth encryption data is a vehicle back-end 340. The generation of the Bluetooth encryption data can be undertaken by the vehicle back-end before a first-time connection is attempted to be set up between the vehicle 310 and the user equipment 330 to be newly added, for instance before a Bluetooth pairing is carried out. The vehicle back-end 340 then sends the generated Bluetooth encryption data to the vehicle 310 and to the user equipment 330 to be newly added. As a result, the user equipment 330 to be newly added can connect to the vehicle 310 by means of Bluetooth without having to set up a first-time connection. For instance, as a result a first unsecure connection before, for instance, PAKE has been carried out can be prevented. The vehicle 310 and the user equipment 330 to be newly added can substantially carry out a synchronization of the out-of-band information. As a result, in particular after the synchronizing of the Bluetooth encryption data a first-time establishment of a Bluetooth connection can be started directly. For instance, a Bluetooth pairing can be started without a further exchange of out-of-band information between the vehicle 310 and the user equipment 330 to be added being required.

Optionally, during a Bluetooth pairing between the master apparatus 320 and the vehicle 310 the Bluetooth encryption data needed can be sent directly from the vehicle 310 to the master apparatus 320. A generation of Bluetooth encryption data by the master apparatus 320 may no longer be required. In particular, the Bluetooth encryption data can be sent from the vehicle 310 to the master apparatus 320 over a secure connection during the master-apparatus pairing. A communication of information to the master apparatus 320 during the key-exchange may also no longer be necessary. The master-apparatus pairing can serve, in particular, for training the master apparatus 320 to the vehicle 310. The master-apparatus pairing can be undertaken, for instance, by means of WPAN, for example Bluetooth, WLAN, etc. The master-apparatus pairing can, for instance, be undertaken in accordance with CCC standards. For instance, use can be made of standard CCC-TS-101, Digital Key Technical Specification Release 3, Version 1.0.0, Chapter 6.

The vehicle back-end 340 can, in particular, generate and synchronize new Bluetooth encryption data each time it has obtained information for generating Bluetooth encryption data for establishing an encrypted Bluetooth connection between a first user equipment and a second user equipment. Information obtained may include, for instance, information about a new generated/used data key.

The new generated/used data key can be generated, in particular, by way of a sharing of access rights, for instance by the master apparatus 320 and/or by a service data key, for instance by an administrative platform such as the vehicle back-end 340. After obtaining the information and generating the Bluetooth encryption data, the vehicle back-end 340 can then send these data to the vehicle 310 and to the user equipment 330 to be newly added. The sending can, in particular, take place immediately after the generating of the Bluetooth encryption data, or as soon as a connection to the vehicle 310 and/or to the user equipment 330 to be newly added can be set up. This can be done, for instance, by expanding the information that is sent over a secure connection during a tracking of a user equipment 330 to be newly added.

For instance, a manager of a car-sharing fleet can create a data key for a customer by means of an administrative platform. For instance, the vehicle back-end 340 can be used in order to replace a master apparatus 320. Accordingly, in particular no master apparatus 320 has to be present. The user equipment 330 to be newly added can then obtain the (service) data key from the vehicle back-end 340. The (service) data key can be registered at the vehicle back-end 340. Furthermore, the user equipment 330 to be newly added can also obtain the Bluetooth encryption data generated by the vehicle back-end 340, for instance simultaneously with the (service) data key. The vehicle 310 can obtain the same Bluetooth encryption data. Additionally, the vehicle 310 can also obtain the information about the (service) data key, or information that permits an identification of the user equipment 330 to be newly added. As a result, a first first-time connection for a Bluetooth connection can then be improved.

For instance, a user of a master apparatus 320 may wish to enable a friend to have access to his/her vehicle 310. For this purpose, the user can send, by means of his/her master apparatus 320, a data key to his/her friend's user equipment 330 to be newly added. The data key can then be registered at the vehicle back-end 340. Furthermore, the user equipment 330 to be newly added can obtain the Bluetooth encryption data generated by the vehicle back-end 340. In this case, the obtaining of the data key may be separate from the obtaining of the Bluetooth encryption data. Alternatively, the master apparatus 320 can also generate the Bluetooth encryption data. In this case, no vehicle back-end 340 may then be present.

Further particulars and aspects are mentioned in connection with the embodiments described below and/or above. The embodiment shown in FIG. 4 may include one or more optional additional features that correspond to one or more aspects that were mentioned in connection with the proposed concept or in connection with one or more embodiments described above (for example, FIGS. 1-3) and/or below (for example, FIG. 5).

FIG. 5 shows two schematic representations for generating and for exchanging Bluetooth encryption data. FIG. 5a shows the prior art. As can be discerned in the prior art, a negotiation of the LTK takes place only after a first initial connection between the vehicle 310 and the new UE 330 has been established, for instance after a first establishment of a Bluetooth connection has taken place. As a result, unnecessary waiting-times arise for a user of the new UE 330, which may impair a user experience.

FIG. 5b shows a schematic representation of an example of a method according to the disclosure, for instance an embodiment of a method that was described with reference to FIG. 1.

In FIG. 5b, the network component 340 which generates and synchronizes the Bluetooth control data is a vehicle back-end 340. In particular, the vehicle back-end 340 generates Bluetooth pairing data, in particular including an LTK. The generation of the Bluetooth control data can be undertaken by the vehicle back-end before an attempt is made to set up a first-time connection between the vehicle 310 and the user equipment 330 to be newly added, for instance before a Bluetooth pairing is carried out. In particular, an establishment of an initial Bluetooth connection by means of Bluetooth pairing can be avoided or replaced by the generation and synchronization of the Bluetooth control data.

The vehicle back-end 340 can then send the generated Bluetooth control data to the vehicle 310 and to the user equipment 330 to be newly added. As a result, the user equipment 330 to be newly added can connect to the vehicle 310 by means of Bluetooth without having to set up a first-time connection, in particular without having to set up an initial Bluetooth connection, since an LTK may already be known. For instance, an LTK can thereby be synchronized directly between the vehicle 310 and the new user equipment 330. As a result, a Bluetooth pairing process, in particular a Bluetooth low-energy pairing process, may already become unnecessary at the time of a first contact between the vehicle 310 and the new user equipment 330. In particular, a user experience can thereby be enhanced. A user experience upon initial contact with the vehicle may be impaired if as a result of the Bluetooth pairing process a delay arises in the sequence of operations (for example, when unlocking the vehicle). By virtue of the prior synchronization of the LTK, this delay can be avoided. In particular, a persistence of both communication partners—the vehicle 310 and the user equipment 330—in an LTK, in order to be able to set up a secure connection directly upon subsequent contacts, may become unnecessary after a Bluetooth pairing.

The vehicle 310 and the user equipment 330 to be newly added can substantially carry out a synchronization of all the information needed for a Bluetooth connection. As a result, a first-time establishment of a Bluetooth connection may become unnecessary, in particular after the synchronizing of the Bluetooth control data (Bluetooth pairing data). The vehicle 310 and the new user equipment 330 can accordingly set up a Bluetooth connection directly. For instance, a persistence of an LTK after a Bluetooth pairing may not be necessary.

Optionally, during a Bluetooth pairing between the master apparatus 320 and the vehicle 310 the Bluetooth control data (Bluetooth pairing data) needed can be sent directly from the vehicle 310 to the master apparatus 320. A generation of Bluetooth control data (Bluetooth pairing data) by the master apparatus, the vehicle 310 and the new user equipment 330 may no longer be required.

The vehicle back-end 340 can, in particular, generate and synchronize new Bluetooth encryption data each time it has obtained information for generating Bluetooth encryption data for establishing an encrypted Bluetooth connection between a first user equipment and a second user equipment. Information obtained may include, for instance, information about a newly generated/used data key. The new generated/used data key can be generated, in particular, by way of a sharing of access rights, for instance by the master apparatus 320 and/or by a service data key, for instance by an administrative platform such as the vehicle back-end 340. After obtaining the information and generating the Bluetooth encryption data, the vehicle back-end 340 can then send these data to the vehicle 310 and to the user equipment 330 to be newly added. The sending can, in particular, take place immediately after the generating of the Bluetooth encryption data, or as soon as a connection to the vehicle 310 and/or to the user equipment 330 to be newly added can be set up. This can be effected, for instance, by expanding the information that is sent over a secure connection during a tracking of a user equipment 330 to be newly added.

An exemplary generation of the Bluetooth control data is presented in more detail in the following.

Reference is made to the CCC standard, Digital Key Technical Specification Release 3 v1 0.0, [CCC-R3].[CCC-R3] currently describes merely a concept of the CCC specifications. However, it does not describe any possibility for implementing Bluetooth control data.

The Bluetooth control data may, for instance, have been defined as follows:
IRK:
   used in order to resolve the ADV_IND of the vehicle.
BT_ADDR_CAR:
   optional
   used for establishing a Bluetooth connection.
LTK:
   used for a secure (transmission) channel.

In general, certain parameters, such as [OBLE-001] for example, may be needed. Firstly, in the course of a key-exchange there may be a need for the Bluetooth control data to be synchronized, for instance between a vehicle back-end and the vehicle.

The following changes can be carried out in the course of the master-apparatus pairing:

### General:

[OBLE-201]: In order to ensure [OBLE-001], the Bluetooth control data can be synchronized between a vehicle back-end and a vehicle, specifically before a master-apparatus pairing takes place. The generation of the control data and the synchronization can be undertaken in accordance with one of the methods described above, for instance as described with reference to FIG. 1 or FIG. 2.

### 7F49 Template:

[OBLE-202] 7F49 Template: Adding a 0xD5 tag, so that:
If the vehicle supports a retrieval of the Bluetooth control data, the 0xD5 tag can be presented during the master-apparatus pairing. The tag may include an LTK that was determined in [OBLE-001].

### Bluetooth Pairing

[OBLE-203] “Bluetooth LE Pairing & Encryption Setup Procedure” (as described on 347 ff. [CCC-R3]) can be skipped. The generated/synchronized LTKs can then be utilized in order to set up a secure Bluetooth connection.

Furthermore, changes can be made in the course of the key-exchange.

### 7F49 Template:

[OBLE-204] 7F49 Template: Adding a 0xD5 tag, so that:
If the vehicle supports a retrieval of the Bluetooth control data, the 0xD5 tag can be presented during the master-apparatus pairing. The tag may include an LTK that was determined in [OBLE-001].

### First Initial Connection in the Course of Bluetooth Pairing

[OBLE-205] The “Bluetooth LE Pairing & Encryption Setup Procedure” (as described on 347 ff. [CCC-R3]) can be skipped. The generated/synchronized LTKs can then be utilized in order to set up a secure Bluetooth connection.

Moreover, changes can be carried out in the course of the tracking of a key:

trackKeyResponse ( ): [OBLE-206] Adding the following parameter to trackKeyResponse ( )

| | | Max. | | |
|---|---|---|---|---|
| Parameter | Type | Length | Description | Needed |
| Vehicle | Encrypted | 4096 | Encrypted | Conditions |
| BLE key | data | | from the | needed for |
| (vehicle | container | | vehicle | the |
| Bluetooth | (see | | (first UE) | friend's |
| control | section | | to the | key if the |
| data) | 17.8.5) | | second UE. | vehicle |
| | | | Encrypted | supports |
| | | | by device. | the |
| | | | Enc.PK as | retrieval |
| | | | defined in | of the |
| | | | section 14. | Bluetooth |
| | | | Reference | control |
| | | | to | data |
| | | | unencrypted | |
| | | | vehicle BLE | |
| | | | key | |

[OBLE-207] Add Chapter “Unencrypted Vehicle BLE Key Fields” with the following content:

| | | Max. | | |
|---|---|---|---|---|
| Parameter | Type | Length | Description | Needed |
| LTK | String | 16 | LTK as | Conditions |
| | | | determined | needed for |
| | | | in [OBLE- | the |
| | | | 001] | friend's |
| | | | | key if the |
| | | | | vehicle |
| | | | | supports |
| | | | | the |
| | | | | retrieval |
| | | | | of the |
| | | | | Bluetooth |
| | | | | control |
| | | | | data |

Further particulars and aspects are mentioned in connection with the embodiments described above. The embodiment shown in FIG. 5 may include one or more optional additional features that correspond to one or more aspects that were mentioned in connection with the proposed concept or in connection with one or more embodiments described above (for example, FIGS. 1-4).

Further embodiments are computer programs for carrying out one of the methods described herein when the computer program is running on a computer, on a processor, or on a programmable hardware component. Depending upon specific implementation requirements, embodiments of the disclosure may have been implemented in hardware or in software. The implementation can be carried out using a digital storage medium, for instance a floppy disk, a DVD, a Blu-ray disc, a CD, a ROM, a PROM, an EPROM, an EEPROM or a flash memory, a hard disk or another magnetic or optical storage unit on which electronically readable control signals have been stored that are able to interact, or that interact, with a programmable hardware component in such a manner that the respective method is carried out.

A programmable hardware component may be constituted by a processor, a computer processor (CPU=central processing unit), a graphics processor (GPU=graphics processing unit), a computer, a computer system, an application-specific integrated circuit (ASIC), an integrated circuit (IC), an on-chip system (SOC=system on chip), a programmable logic element or a field-programmable gate array with a microprocessor (FPGA).

The digital storage medium may therefore be machine-readable or computer-readable. Some embodiments accordingly include a data-carrier that features electronically readable control signals that are capable of interacting with a programmable computer system or with a programmable hardware component in such a manner that one of the methods described herein is carried out. One embodiment is consequently a data-carrier (or a digital storage medium or a computer-readable medium) on which the program for carrying out one of the methods described herein has been recorded.

In general, embodiments of the present disclosure may have been implemented as a program, firmware, computer program or computer-program product with program code, or as data, the program code or the data being effective in carrying out one of the methods when the program is running on a processor or on a programmable hardware component. The program code or the data may, for instance, also have been stored on a machine-readable carrier or data-carrier. The program code or the data may be present as, amongst other things, source code, machine code or byte code, and also as other intermediate code.

The embodiments described above represent merely an illustration of the principles of the present disclosure. It will be understood that modifications and variations of the arrangements and particulars described herein will be evident to other persons skilled in the art. It is therefore intended that the disclosure be restricted merely by the scope of protection of the following claims, and not by the specific particulars that have been presented herein with the aid of the description and the elucidation of the embodiments.

### LIST OF REFERENCE SYMBOLS

30 device
32 interface
34 control module
100 method for providing Bluetooth encryption data
110 obtaining information
120 generating the Bluetooth encryption data
130 synchronizing the Bluetooth encryption data
310 vehicle
320 master apparatus
330 user equipment to be newly added
340 vehicle back-end

1.-10. (canceled)

11. A method for a network component for providing Bluetooth control data, comprising:
obtaining information for generating Bluetooth control data for establishing an encrypted Bluetooth connection between a first user equipment and a second user equipment on the basis of the information obtained;
generating the Bluetooth control data; and
synchronizing the Bluetooth control data between the first user equipment and the second user equipment.

12. The method as claimed in claim 11, wherein the information obtained includes an identification for at least the first user equipment or the second user equipment.

13. The method as claimed in claim 12, wherein the Bluetooth control data are Bluetooth encryption data.

14. The method as claimed in claim 13, wherein the Bluetooth control data are Bluetooth pairing data.

15. The method as claimed in claim 14, wherein the information obtained includes an identification for at least the first user equipment or the second user equipment.

16. The method as claimed in claim 15, wherein the network component is an administrative platform or a further user equipment.

17. The method as claimed in claim 16, further comprising encrypting the Bluetooth control data for the purpose of synchronization.

18. A non-transient computer readable medium for providing Bluetooth control data, wherein the computer-readable medium comprises instructions which, when executed on a processor, causes the processor to:
obtain information for generating Bluetooth control data for establishing an encrypted Bluetooth connection between a first user equipment and a second user equipment on the basis of the information obtained;
generate the Bluetooth control data; and
synchronize the Bluetooth control data between the first user equipment and the second user equipment.

19. The non-transient computer readable medium as claimed in claim 18, wherein
the information obtained includes an identification for at least the first user equipment or the second user equipment.

20. The non-transient computer readable medium as claimed in claim 19, wherein the Bluetooth control data are Bluetooth encryption data.

21. The non-transient computer readable medium as claimed in claim 20, wherein the Bluetooth control data are Bluetooth pairing data.

22. The non-transient computer readable medium as claimed in claim 21, wherein the information obtained includes an identification for at least the first user equipment or the second user equipment.

23. The non-transient computer readable medium as claimed in claim 22, wherein the network component is an administrative platform or a further user equipment.

24. The non-transient computer readable medium as claimed in claim 23, wherein the computer-readable medium further comprises instructions which, when executed on the processor, causes the processor to:
encrypt the Bluetooth control data for the purpose of synchronization.

25. A vehicle with a device for a network component for providing Bluetooth control data, the device comprising:
one or more interfaces for communication with a first user equipment and a second user equipment; and
a controller in communication with the one or more interfaces, the controller configured to:
obtain information for generating Bluetooth control data for establishing an encrypted Bluetooth connection between the first user equipment and the second user equipment on the basis of the information obtained;
generate the Bluetooth control data; and
synchronize the Bluetooth control data between the first user equipment and the second user equipment.

26. The vehicle as claimed in claim 25, wherein the information obtained includes an identification for at least the first user equipment or the second user equipment.

27. The vehicle as claimed in claim 26, wherein the Bluetooth control data are Bluetooth encryption data.

28. The vehicle as claimed in claim 27, wherein the Bluetooth control data are Bluetooth pairing data.

29. The vehicle as claimed in claim 28, wherein the information obtained includes an identification for at least the first user equipment or the second user equipment.

30. The vehicle as claimed in claim 29, wherein the network component is an administrative platform or a further user equipment.
